(19) United States
(12) Patent Application Publication
(10) Pub. No.: US 2008/0272702 A1
(43) Pub. Date: Nov. 6, 2008

(54) Device for Determining Characteristics a Lighting Unit

(75) Inventors: Josephus Adrianus Maria Van Erp, Eindhoven (NL); Wilhelmus Adrianus Gerardus Timmers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,041

(22) PCT Filed: Dec. 1, 2006
(86) PCT No.: PCT/IB2006/054545

§ 371 Date: Jun. 4, 2008

(30) Foreign Application Priority Data
Dec. 9, 2005 (EP) 05111873.5
Apr. 25, 2006 (EP) 06113054.8

(51) Int. Cl. H05B 37/02; G01J 3/50

(52) U.S. Cl. 315/151; 356/402

(57) ABSTRACT

The present invention relates to a device for determining characteristics of a lighting unit, comprising at least two flux sensor each having different wavelength characteristics and being arranged to measure light emitted from the lighting unit, yielding two measurements, and means for calculating a dominant wavelength and a real flux for the lighting unit based on the measurements and the sensors' wavelength characteristics. The present invention provides for a direct calculation of dominant wavelength and real flux without the need for predefined data about the light source or without performing additional measurements such as using temperature measurements. The present invention also relates to a system using such a device, and a corresponding method for determining characteristics of a lighting unit.

The present invention relates to a device and method for determining characteristics of a lighting unit. The invention also relates to a lighting system comprising such a device.

Mixing multiple colored LEDs to obtain a mixed color is a common way to generate white or colored light in a lighting device. The generated light is determined by the type of LEDs used, as well as by the mixing ratios. However, the optical characteristics of the LEDs change during the LEDs components lifecycle, and when the LEDs rise in temperature during operation the flux output decreases and the peak wavelength shifts. As a result, the light emitted from the lighting device will vary in intensity and wavelength depending on temperature and component ageing.

To overcome or alleviate this problem, various color control systems have been proposed in order to compensate for these changes in optical characteristics of the LEDs during use. For example, a system for measuring quantitative (light intensity) and spectral (wavelength) information from a light source (multi-chip LED-package) is disclosed in U.S. Pat. No. 6,617,795. The information is in turn provided to an external controller that uses the information to correct for quantitative and spectral variations in the light source. The described system uses both a photo sensor and a thermal sensor to achieve reliable measurement results. This limits the disclosed system as the sensors has to be thermally coupled to a thermally conductive support member to which the light source is coupled. Furthermore, to achieve reasonable correction for the quantitative and spectral variations in the light source, the initial quality of the light source has to be known (binning), how the light source reacts to temperature variations, and how the light source changes over time (aging).

It is therefore an object of the present invention to provide a device for determining characteristics of a light source which substantially overcomes the disadvantages of the prior art devices and systems, while providing further improvements in terms of cost, space and manufacturing convenience.

The above object is met by a device and method for determining characteristics of a lighting unit as defined in the appended claim 1 and claim 15, respectively. Furthermore, an advantageous lighting system using such a device is defined in claim 8. The appended sub-claims define advantageous embodiments in accordance with the present invention.

According to an aspect of the invention, there is provided a device for determining characteristics of a lighting unit, comprising at least two flux sensors, each having different wavelength characteristics and being arranged to measure light emitted from the lighting unit, yielding two measurements, and means for calculating a dominant wavelength and a real flux for the lighting unit based on said measurements and the sensors' wavelength characteristics.

The invention is based on the understanding that by measuring the light from the lighting unit with (at least) two flux sensors having different wavelength characteristics, these measurement together with data of the sensors' wavelength characteristics can be used to directly calculate the dominant wave and real flux of the lighting unit, without the need for predefined data about the light source or without performing additional measurements such as using temperature measurements. Different wavelength characteristics should be understood, in this context, to mean that each of the flux sensors have different spectral response (wavelength sensitivity).

In a preferred embodiment of the present invention, at least two of the flux sensors have different wavelength dependencies, yielding a wavelength dependent flux measurement for each sensor. Different wavelength dependency should be understood, in this context, to mean that each of the flux sensors have different spectral response (wavelength sensitivity). Due to this different spectral response for the flux sensors, the measurement results will be different for each of the flux sensors, thus enabling simple calculations of the dominant wavelength and the real flux for the lighting unit based on the wavelength dependent measurements from the at least two flux sensors and the flux sensors wavelength dependencies. Consequently, this aspect of the present invention provides for a direct calculation of dominant wavelength and real flux without the need for predefined data about the light source or without performing additional measurements such as using temperature measurements. A wavelength dependent flux measurement is preferably provided by means of a filtered sensor, where different filter windows are used to tailor the spectral response of the flux sensors to suit the application. Such filtered sensors are inexpensive standard components, whereby the device can be realized in a cost effective fashion.

In another preferred embodiment, at least one of the flux sensors is wavelength dependent yielding a wavelength dependent flux measurement, as described above, and at least one of the flux sensors is wavelength independent, or essentially wavelength independent, yielding a wavelength independent flux measurement. An essentially wavelength independent flux measurement is preferably provided by means of a sensor having an essentially flat spectral response, i.e. a sensor having an essentially wavelength independent sensitivity over the wavelengths of interest. In a typical lighting unit, this interesting wavelength range is approximately 380 nm to 750 nm. In this embodiment, the sensor having an essentially flat spectral response provides the total flux for the light emitted by the lighting unit, and the filtered sensor together with the sensor having an essentially flat spectral response will give the wavelength shift compared to a calibration value.

Preferably, in order to calculate the wavelength and flux, the calculation means is adapted to solve a set of at least two equations in which each equation comprises the measurement and wavelength dependency for a different sensor, and the dominant wavelength and the real flux are unknown. For example in one case where two sensors are used, a set of two equations can be solved by linear combination, thus providing for a simple calculation rendering both dominant wavelength and real flux.

Preferably, the wavelength sensitivity of a sensor i can be described with a formula. The simplest form of this formula is essentially

φᵢ=φₛ(cᵢ+αᵢλₛ)

where φᵢ represents the wavelength dependent flux measurement, φₛ represents the real flux, cᵢ and αᵢ are constants describing the sensors wavelength dependency, and λₛ represents the dominant wavelength. However, a sensor used in the present invention might behave differently. For example, one or both of the constants can be exponential or quadratic dependent of φₛ. In the embodiment where one of the flux sensors is an essentially wavelength independent flux sensor, the constant αᵢ describing the sensors wavelength dependency is 0 for the wavelength independent flux sensor.

Furthermore, each equation preferably comprises a further constant, Kᵢ, describing the optical loss for the sensor, thus φᵢ is further dependent on Kᵢ. The constant Kᵢ is preferably determined in a single calibration step. Optical loss generally relates to the placement of the sensors in relation to the placement of the at least one light source.

The device can further comprise a temperature sensor to compensate for temperature dependency in said flux sensors. This provides for improved measurement accuracy, and furthermore compensates for temperature variations that in some cases will affect the spectral response of the flux sensors.

According to another aspect of the present invention, there is provided a lighting system comprising a lighting unit, a device as described above for determining characteristics of the lighting unit, and means for adjusting the output of the lighting unit, in accordance with at least one of the wavelength and wavelength independent flux determined by said device, to compensate for variations in the characteristics of said lighting unit.

The means for adjusting the output of the lighting unit can for example be arranged to compare desired color points and/or color temperatures with an actual measurement, and depending on the difference, adjust the output of the lighting unit for intensity and wavelength variations that relates to for example ambient temperature and aging of the lighting unit. It is thereby possible to maintain the desired setting regardless of aging or ambient temperature.

The lighting unit can for example be a color variable lighting unit, and the lighting unit can be a LED based lighting unit. Further, the lighting unit can comprise at least two light sources of different colors, each light source for example comprising at least one LED, thus enabling the possibility to generate white or colored light at different color temperatures. To provide for a more accurate control and adjustment of the lighting unit comprising light sources of different colors, the determination can be made for one color at a time, preferably sequentially. This makes it possible to determine both the dominant wavelength and the real flux for each of the colors. Given the new dominant wavelengths and real fluxes for each of the colors, it is possible to calculate new color points so that the initial (or a desired) total color point is maintained. In other words, it is possible to independently apply a required correction for the dominant wavelength, λₛ, and for the real flux, φₛ. Furthermore, by scaling the fluxes for each color, a total flux for the lighting system can be calculated.

Depending on the type of implementation, the determination and adjustment can be done continuous. This provides for direct adjustment in case of for example fast variations in ambient temperature.

Further, the adjustment of the output of the lighting unit for intensity and wavelength variations can either be done direct or indirect depending on the color correction adjustment algorithms used. Direct adjustment can for example represent a comparison to a set-point value representing a desired output from the lighting unit, where the difference should be close to zero, whereas indirect adjustment can represent a compensation or re-calculation of the set-point values representing a desired output from the lighting unit.

According to yet another aspect of the present invention, there is provided a method for determining characteristics of a light source, the method comprising the steps of measuring light emitted from a lighting unit by means of at least two flux sensors each having different wavelength characteristics, yielding two flux measurements, and calculating a dominant wavelength and a real flux for the lighting unit based on said measurements and the sensors' wavelength characteristics. This method offers similar advantages as the previously discussed aspects of the invention as described above.

These and other aspects of the present invention will now be described in more detail, with reference to the appended drawings showing a currently preferred embodiment of the invention.

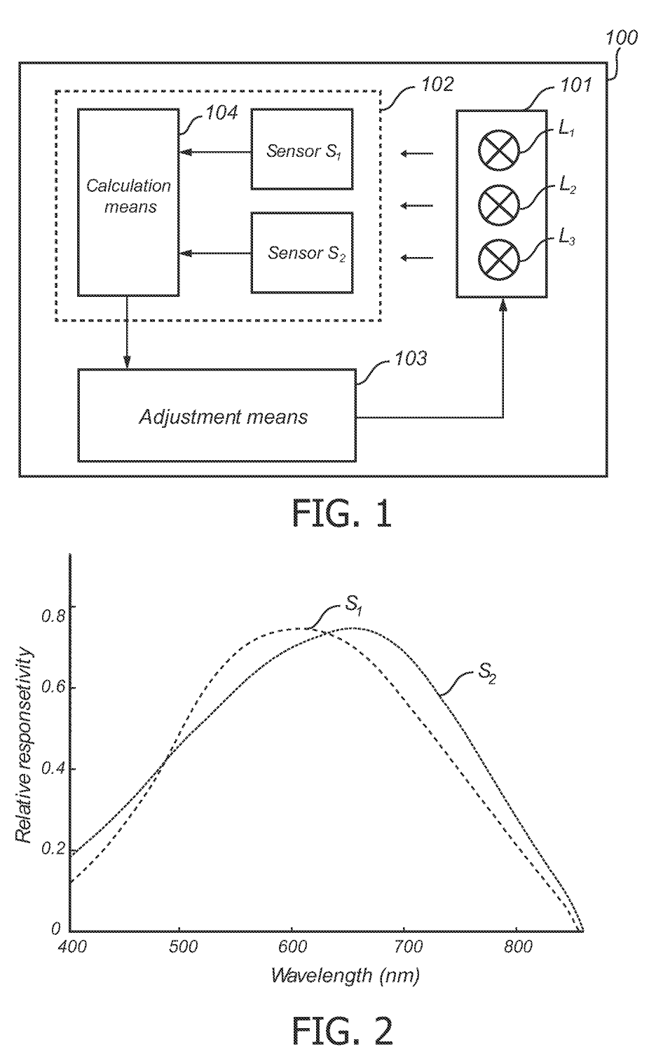

FIG. 1 is a block diagram of a lighting system according to a currently preferred embodiment of the present invention.

FIG. 2 is a graph showing the wavelength dependent relative responsively for two filtered flux sensors according to a currently preferred embodiment of the present invention.

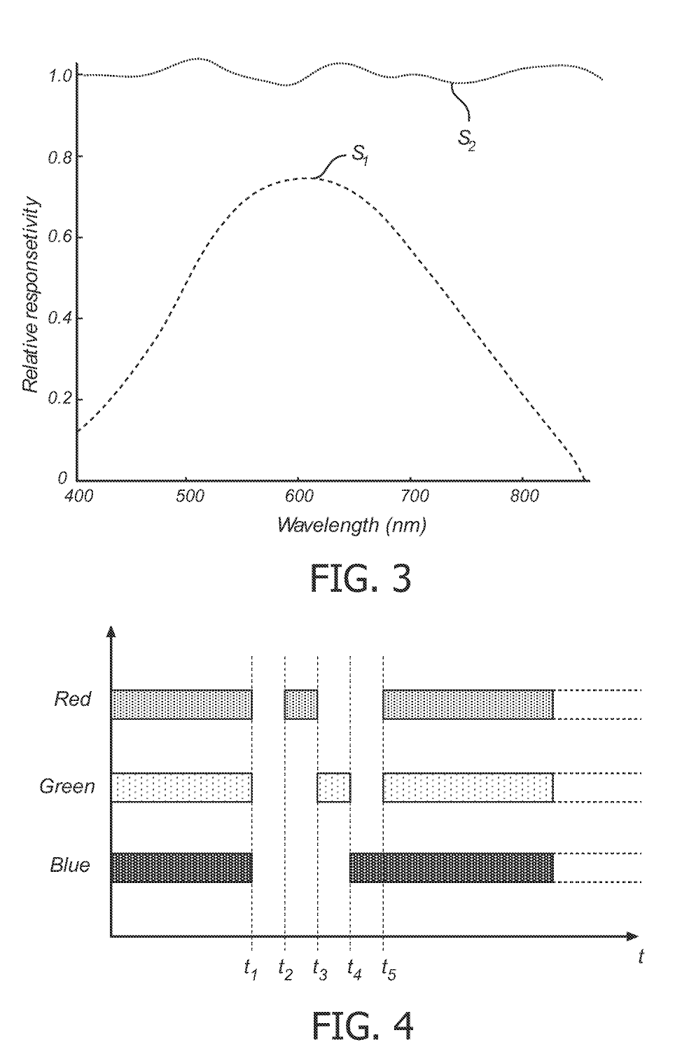

FIG. 3 is a graph showing the wavelength dependent relative responsively for one filtered flux sensor and one flux sensor having an essentially flat spectral response according to another preferred embodiment of the present invention.

FIG. 4 illustrates a measurement cycle where a lighting unit comprises three differently colored light sources.

In FIG. 1, a lighting system 100 according to a currently preferred embodiment of the present invention is shown. The lighting system 100 comprises a lighting unit 101 including three different colored light sources, such as three LEDs L₁-L₃, a device 102 for determining characteristics of the lighting unit 101, and adjustment means 103 for adjusting the light emitted from the lighting unit 101. The adjustment means 103 is coupled to both the device 102 and the lighting unit 101.

Furthermore, the device 102 in turn comprises two wavelength dependent flux sensors S₁ and S₂ for generating a wavelength dependent flux measurement for each of the sensors S₁ and S₂, and a calculation means 104, coupled to the sensors S₁ and S₂, for calculating a dominant wavelength and a real flux for each of the LEDs based on the measurements and the sensors' wavelength dependencies.

Upon operation of the lighting system 100, a user input corresponding to a desired color is initially input. The desired color is achieved by adjustments of the output from the lighting unit 101 (by tuning the amount of the output from the three LEDs L₁-L₃, for example one red, one green, and one blue LED). It would of course be possible to use more than three LEDs, and/or at least two LEDs.

However, as mentioned above, the output of the LEDs tend to vary in intensity and wavelength during operation depending on temperature and component ageing. Therefore, upon operation of the lighting system, the light from each of the LEDs is individually measured using the two wavelength dependent flux sensors S₁ and S₂, for example by time shifting the output for each of the LEDs. Thereafter, the calculation means 104 calculates a dominant wavelength and a real flux for each of the LEDs.

The operation of the device will now be described in detail. The equations for each of the sensors are, as described above, essentially:

φᵢ=φₛKᵢ(cᵢ+αᵢλₛ)

where θᵢ represents the wavelength dependent flux measurement, φₛ represents the real flux, Kᵢ represents the optical loss for the sensor, cᵢ and αᵢ are constants describing the sensors wavelength dependency, and XS represents the dominant wavelength.

However, it would also be possible to instead of the two wavelength dependent flux sensors S₁ and S₂, let the device 102 comprise one wavelength dependent flux sensor S₁, yielding a wavelength dependent flux measurement as above, and one wavelength independent flux sensor S₂, yielding a wavelength independent flux measurement. By means of these two sensors S₁ and S₂, it is also possible to, as will be described below, calculate a dominant wavelength and a real flux for each of the LEDs based on the measurements and the sensors' wavelength characteristics.

FIG. 2 illustrates in a graph the wavelength dependent relative responsively for two exemplary flux sensors S₁ and S₂. To characterize a lighting unit comprising three LED light sources of for example red, green and blue color, the two flux sensors will both measure the flux for each of the colors (for example by time multiplexing, where one light source will emit light at a time, further described below with reference to FIG. 4). The dominant wavelength, λₛ, and the real flux, φₛ for each of the LEDs can in one case, where the device 102 comprises two sensors S₁ and S₂, be calculated using linear combination by combining two flux sensor equations (i=1 and i=2) as described above, rendering:

$${φ}_{s} = \frac{{K}_{2} {α}_{2} {φ}_{1} - {K}_{1} {α}_{1} {φ}_{2}}{{K}_{1} {K}_{2} ( {α}_{2} {c}_{1} - {α}_{1} {c}_{2} )} {λ}_{s} = \frac{{φ}_{1}}{{φ}_{s} {K}_{1} {α}_{1}} - \frac{{c}_{1}}{{α}_{1}}$$

Linear combination is made possible since the two flux sensors S₁ and S₂ have different wavelength dependency (i.e. at least one of the wavelength dependent constants cᵢ and αᵢ for the sensor differs). Knowledge of the sensor wavelength dependent constants are of course needed.

However, as described above, it is also possible to include one wavelength dependent flux sensor S₁ and one essentially wavelength independent flux sensor S₂, i.e. a sensor having an essentially flat sensitivity response, responsibility, over the interesting wavelength range. FIG. 3 illustrates such a case, in which a graph shows the wavelength dependency relative to the responsively for one filtered flux sensor S₁ and one flux sensor S₂ having an essentially flat spectral response. In this case, the flux sensor S₂, with an essentially flat response over wavelength provide the flux for all of the colors, and the flux sensor with the dependent response over wavelength, i.e. flux sensor S₁, together with the flux sensor S₂, will give the wavelength shift compared to a calibration value. This is a special case of the above discussed equation, wherein the wavelength dependency for the sensor S₂ is 0, i.e. α₂=0.

Turning back to the lighting system 100, where after accurate calculation of the dominant wavelength and the real flux, proper adjustments can be done by continuously performing the calculation of the dominant wavelength and the real flux for each of the LEDs, and comparing the new values with earlier values, and depending on the difference, adjusting the output of the lighting unit for intensity and wavelength variations that relates to temperature and aging of the lighting unit. It is thereby possible to maintain the initial color setting regardless of aging or ambient temperature, and without knowing the binning-, aging- and/or temperature sensitivity data for the LEDs. The currently preferred embodiment has been described using three light sources, but the person skilled in the art realizes that the method will work with two or more light sources (LEDs). Furthermore, it would be possible to increase the number of sensors to increase the accuracy of the measurement.

In another embodiment, wherein the device 102 comprises one wavelength dependent flux sensor S₁ and one wavelength independent flux sensor S₂, the lighting system may be calibrated initially, yielding a reference lambda value and a reference absolute flux value. Theses reference values may be stored in the calculation means 104. All future measurements are then referred to these values from which a calibration factor is calculated. In this case the flux sensor S₂ measures the absolute flux and compares this value to the calibration value measured during the initial calibration. This will enable the calculation means 104 to, in collaboration with the adjustment means 103, compensate for an increase or decrease in an absolute flux due to for example temperature, or due to lifetime degradation of the LEDs L₁-L₃. When the absolute flux value is known by measurements with the flux sensor S₂, it is possible to calculate a lambda shift compared to the reference lambda value, which was calculated during the initial calibration. With both these values it is possible to maintain an essentially constant color output of the lighting system 100 over temperature and lifetime. Reference values could also be used when two wavelength dependent flux sensors are utilized as above.

Turning now to FIG. 4, wherein an example of a time multiplexing measurement-switching pattern which can be used in the lighting system of FIG. 1 is shown. The switching pattern as shown in FIG. 4 is a sequential switching pattern, where at t₁ all the LEDs L₁-L₃ are turned off. Some time between t₁ and t₂ the calculation means 104 will sample the flux sensors S₁ and S₂, thereby obtaining flux information relating to the ambient lighting. This ambient flux information may if desired be used to adjust the succeeding measurements for ambient lighting. As understood by the skilled addressee, it would be possible to perform multiple sampling of each of the measurements to achieve a higher accuracy. At t₂, the red LED L₁ is turned on and calculation means 104 will sample the flux sensors S₁ and S₂. Subsequently at t₃, the red LED L₁ is turned off, and the green LED L₂ is turned on. The calculation means 104 once again sample the flux sensors S₁ and S₂ to acquire a measurement for the green LED L₂. The same measurement step is repeated for the blue LED L₃. After that, the calculation means 104 will calculate a color point for each of the LEDs, compare them to desired color points and adjust the drive signals to each of the LEDs such that the desired color is obtained.

It is understood that it would be possible to use any other type of predetermined switching pattern. For example, it would be possible to use an inverted type of switching pattern, as compared to the switching pattern shown in FIG. 4, where instead of turning off all of the LEDs L₁-L₃, only one of the LEDs will be turned off at a time. By means of a system of equations it will then be possible to calculate the individual color points for each of the differently colored LEDs. However, this will require a more complex deconvolution process, in turn requiring that the calculation means 104 is adapted to perform more complex signal processing. In relation to cost this might not be desirable, but it would be possible to let design and implementation approach determine what type of switching pattern that should be used. Furthermore, in a pulse width modulation system (PWM) it would be possible to “stretch” the switching pattern over more than one PWM cycle to obtain as high as possible PWM close to 100%. The sequence could also skip some PWM cycles before it is activated.

The person skilled in the art realizes that the present invention by no means is limited to the preferred embodiments described above. On the contrary, many modifications and variations are possible within the scope of the appended claims. For example, it is possible to use a temperature sensor to compensate for variations in the spectral response of the flux sensors that relates to ambient temperature variations. Furthermore, the present invention can advantageously be used with other types of light sources, such as OLEDs, PLEDs, inorganic LEDs, lasers, CCFL, HCFL, plasma lamps or a combination thereof.

1. A device for determining characteristics of a lighting unit, comprising:
at least two flux sensor each having different wavelength characteristics and being arranged to measure light emitted from said lighting unit, yielding two measurements; and
means for calculating a dominant wavelength and a real flux for said lighting unit based on said measurements and said sensors wavelength characteristics.

2. A device according to claim 1, wherein at least two of said flux sensors have different wavelength dependencies, yielding a wavelength dependent flux measurement for each sensor.

3. A device according to claim 1, wherein at least one of said flux sensors is wavelength dependent yielding a wavelength dependent flux measurement, and at least one of said flux sensors is wavelength independent yielding a wavelength independent flux measurement.

4. A device according to claim 1, wherein the calculation means is further adapted to solve a set of at least two equations in which:
each equation comprises the measurement and wavelength characteristics for a different sensor; and
said dominant wavelength and said real flux are unknown.

5. A device according to claim 1, wherein the equation for a sensor i of said sensors is essentially
φᵢ=φₛ(cᵢ+αᵢλₛ)
where φᵢ represents the flux measurement, φₛ represents the real flux, cᵢ and αᵢ are constants describing the sensor's wavelength characteristics, and λₛ represents the dominant wavelength.

6. A device according to claim 1, wherein said device further comprises a temperature sensor to compensate for temperature dependency in said flux sensors.

7. A device according to claim 4, wherein each equation further comprises a constant Kᵢ describing the optical loss for the sensor, which constant preferably is determined in a single calibration step.

8. A lighting system comprising:
a lighting unit;
a device according to claim 1 for determining characteristics of said lighting unit; and
means for adjusting the output of said lighting unit, in accordance with at least one of the dominant wavelength and the real flux determined by said device, to compensate for variations in the characteristics of said lighting unit.

9. A lighting system according to claim 8, wherein said lighting unit is a color variable lighting unit.

10. A lighting system according to claim 8, wherein said lighting unit is a light emitting diode (LED) based lighting unit.

11. A lighting system according to claim 8, wherein said lighting unit comprises at least two light sources of different colors.

12. A system according to according to claim 8, wherein said determination is made for one color at a time, preferably sequential.

13. A lighting system according to claim 8, wherein said determination and adjustment is continuous.

14. A lighting system according to claim 8, wherein said adjustment is direct or indirect.

15. A method for determining characteristics of a light source, comprising the steps of:
measuring light emitted from a lighting unit by means of at least two flux sensors each having different wavelength characteristics, yielding two measurements; and
calculating a dominant wavelength and a real flux for said lighting unit based on said measurements and said sensors wavelength characteristics.
